(19) United States
(12) Patent Application Publication
(10) Pub. No.: US 2024/0227448 A1
(43) Pub. Date: Jul. 11, 2024

(54) NON-PNEUMATIC TIRE WITH MULTI ANGLE TENSION CONTROL REINFORCEMENTS

(71) Applicant: The Carlstar Group LLC, Franklin, TN (US)

(72) Inventors: Bruce Li Wang, Oak Ridge, TN (US); George Finch, Fullerton, CA (US); David Dahl, Jackson, TN (US); Tim Moss, Snohomish, WA (US)

(21) Appl. No.: 18/285,889

(22) PCT Filed: May 3, 2022
(86) PCT No.: PCT/US2022/027511

§ 371 Date: Oct. 6, 2023

Related U.S. Application Data
(60) Provisional application No. 63/183,536, filed on May 3, 2021.

(51) Int. Cl. B60C 7/20; B60C 7/22

(52) U.S. Cl. CPC B60C 7/20; B60C 7/22

(57) ABSTRACT

A non-pneumatic tire is provided. The non-pneumatic tire includes an outer annular portion, an inner annular portion, and a load bearing ring positioned between the outer annular portion and the inner annular portion. The load bearing ring includes at least one reinforcing layer, and each of the at least one reinforcing layers includes one or more strips of multi angle tension control reinforcement (MATCR) material.

### RELATED APPLICATIONS

This application claims the benefit of U.S. Provisional Application Ser. No. 63/183,536, filed May 3, 2021, the entire disclosure of which is incorporated herein by this reference.

### TECHNICAL FIELD

The present disclosure is directed to a non-pneumatic tire and methods of producing the same. In particular, the disclosure is directed to a non-pneumatic tire with a load bearing ring design and methods of producing the same.

### BACKGROUND

For over a century most vehicles have relied primarily on the use of pneumatic tires. While there are various differences in construction, all pneumatic tires include an internal cavity that is filled with pressurized air. When properly inflated these tires effectively support the applied load of a vehicle while providing a comfortable ride for the passengers. However, not only does inflation need to be monitored to maintain ride comfort and fuel economy, over- or under-inflation of pneumatic tires can be dangerous. Additionally, even with proper inflation, pneumatic tires are susceptible to failures such as punctures, blowouts, and tears. After loss of inflation pressure, whether due to puncture, tears, or normal wear, conventional pneumatic tires are capable of very limited use.

In an attempt to address these issues, various different “run flat” tires have been designed that run in an uninflated or underinflated condition for extended periods of time. For example, one type of run flat tire is a “banded run flat tire,” which includes an annular band element that acts as a tension member when the tire is pressurized and a structural compression member when the tire is unpressurized or partially pressurized. Although banded run flat tires allow continued short term use after loss of pressurized air, such as that resulting from a puncture, the constant change in axial geometry can lead to interlaminar shear stress and fracture of the band. More specifically, as the tire rotates the axial geometry of the band constantly changes from circular to flat, which causes the fibers along the inside and outside diameter of the band to elongate and shorten, respectively. Under uninflated conditions this elongation and shortening is significantly increased due to more deflection in the sidewalls, impacting durability and leading to quicker fracture. Therefore, as a hybrid of an otherwise pneumatic tire structure, these tires still rely upon inflation pressure and the drawbacks associated therewith.

Non-pneumatic tires, on the other hand, do not rely on air pressure at all. One example of a non-pneumatic tire is a solid tire. While solid tires do not rely on air pressure for support, they also do not have the flexibility of pneumatic tires and thus lack desirable cushioning and handling characteristics. Another example combines an annular band with spokes connecting the band to an inner annular member or hub. Although these band and spoke tires offer improved cushioning over solid non-pneumatic tires, they still suffer from ride comfort and durability issues. Accordingly, there remains a need in the art for durable non-pneumatic tires that provide a comfortable ride.

### SUMMARY

The presently-disclosed subject matter meets some or all of the above-identified needs, as will become evident to those of ordinary skill in the art after a study of information provided in this document.

This summary describes several embodiments of the presently-disclosed subject matter, and in many cases lists variations and permutations of these embodiments. This summary is merely exemplary of the numerous and varied embodiments. Mention of one or more representative features of a given embodiment is likewise exemplary. Such an embodiment can typically exist with or without the feature(s) mentioned; likewise, those features can be applied to other embodiments of the presently-disclosed subject matter, whether listed in this summary or not. To avoid excessive repetition, this summary does not list or suggest all possible combinations of such features.

In some embodiments, the presently-disclosed subject matter includes a non-pneumatic tire including an outer annular portion; an inner annular portion; and a load bearing ring positioned between the outer annular portion and the inner annular portion; the load bearing ring including at least one reinforcing layer; and each of the at least one reinforcing layers comprising one or more strips of multi angle tension control reinforcement (MATCR) material. In some embodiments, the MATCR material comprises a woven construction including a warp wire and a weft wire. In some embodiments, the warp wire provides circumferential strength to the composite. In some embodiments, the weft wire deforms the warp wire radially, providing tension support and shear modulus in both the radial and lateral directions. In some embodiments, the weft wire provides lateral stiffness. In some embodiments, the warp wire and the weft wire independently have a tensile strength of between 0.1 and 50,000 Newtons. In some embodiments, the weft wire alternates between going over and under each consecutive warp wire. In some embodiments, the weft wire alternates between going over and under every two consecutive warp wires. In some embodiments, the weft wire passes through twisted warp wires. In some embodiments, the warp wire and weft wire independently include up to 40 ends per inch. In some embodiments, the warp wire and weft wire independently include a material selected from the group consisting of cotton, nylon, polyester, aramid, rayon, steel or other strengthening materials, composites, and combinations thereof.

In some embodiments, the at least one reinforcing layer is coated with rubber, other polymer composite materials, or a combination thereof. In some embodiments, the at least one reinforcing layer comprises between 2 and 10 reinforcing layers. In some embodiments, the load bearing ring further comprises an outer matrix material between the at least one reinforcing layer and the outer annular portion and/or an inner matrix material between the at least one reinforcing layer and the inner annular portion. In some embodiments, the outer annular portion includes a tread pattern. In some embodiments, the outer annular portion includes one or more sub-surface layers radially positioned beneath the tread pattern. In some embodiments, the inner annular portion is in direct contact with a wheel hub. In some embodiments, the tire includes a radially inner sidewall and a radially outer sidewall. In some embodiments, the tire further comprises spokes between the load bearing ring and the inner annular portion.

Further features and advantages of the presently-disclosed subject matter will become evident to those of ordinary skill in the art after a study of the description, figures, and non-limiting examples in this document.

### BRIEF DESCRIPTION OF THE DRAWINGS

FIG. 1 shows a perspective view of a non-pneumatic tire.

FIG. 2 shows a perspective view of a Multi Angle Tension Control Reinforcement (MATCR) construction according to embodiments of the disclosure.

FIG. 3 shows another perspective view of a MATCR construction according to embodiments of the disclosure.

FIG. 4 shows another perspective view of a MATCR construction according to embodiments of the disclosure.

FIG. 5 shows a perspective view of a ¼ section of a composite with four reinforcing layers embedded between inner and outer layers of matrix material.

FIG. 6 shows a perspective view of a single layer of reinforcing material according to embodiments of the disclosure. This single layer could be used in different width, angle, and gaps in different layers.

FIG. 7 shows another perspective view of single layer of reinforcing material. This single layer could be used in different width, angle, and gaps in different layers.

FIG. 8 shows a perspective view of a non-pneumatic tire with spokes.

While the disclosure is susceptible to various modifications and alternative forms, specific embodiments thereof have been shown by way of example in the drawings and are herein described below in detail. It should be understood, however, that the description of specific embodiments is not intended to limit the disclosure to cover all modifications, equivalents and alternatives falling within the spirit and scope of the disclosure as defined by the appended claims.

### Definitions

Unless defined otherwise, all technical and scientific terms used herein have the same meaning as commonly understood by one of ordinary skill in the art to which the disclosure belongs. Any methods and materials similar to or equivalent to those described herein can be used in the practice or testing of the present disclosure, including the methods and materials are described below.

Following long-standing patent law convention, the terms “a,” “an,” and “the” refer to “one or more” when used in this application, including the claims. Thus, for example, reference to “a layer” includes a plurality of layers, and so forth.

The terms “comprising,” “including,” and “having” are intended to be inclusive and mean that there may be additional elements other than the listed elements.

Unless otherwise indicated, all numbers expressing quantities of ingredients, properties such as reaction conditions, and so forth used in the specification and claims are to be understood as being modified in all instances by the term “about.” Accordingly, unless indicated to the contrary, the numerical parameters set forth in this specification and claims are approximations that can vary depending upon the desired properties sought to be obtained by the presently-disclosed subject matter.

As used herein, the term “about,” when referring to a value or to an amount of mass, weight, time, volume, concentration, percentage, or the like is meant to encompass variations of in some embodiments ±50%, in some embodiments ±40%, in some embodiments ±30%, in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed method.

As used herein, ranges can be expressed as from “about” one particular value, and/or to “about” another particular value. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

All combinations of method or process steps as used herein can be performed in any order, unless otherwise specified or clearly implied to the contrary by the context in which the referenced combination is made.

As used herein, the terms “optional” or “optionally” means that the subsequently described event or circumstance can or cannot occur, and that the description includes instances where said event or circumstance occurs and instances where it does not.

### DETAILED DESCRIPTION

The details of one or more embodiments of the presently-disclosed subject matter are set forth in this document. Modifications to embodiments described in this document, and other embodiments, will be evident to those of ordinary skill in the art after a study of the information provided in this document. The information provided in this document, and particularly the specific details of the described exemplary embodiments, is provided primarily for clearness of understanding and no unnecessary limitations are to be understood therefrom. In case of conflict, the specification of this document, including definitions, will control.

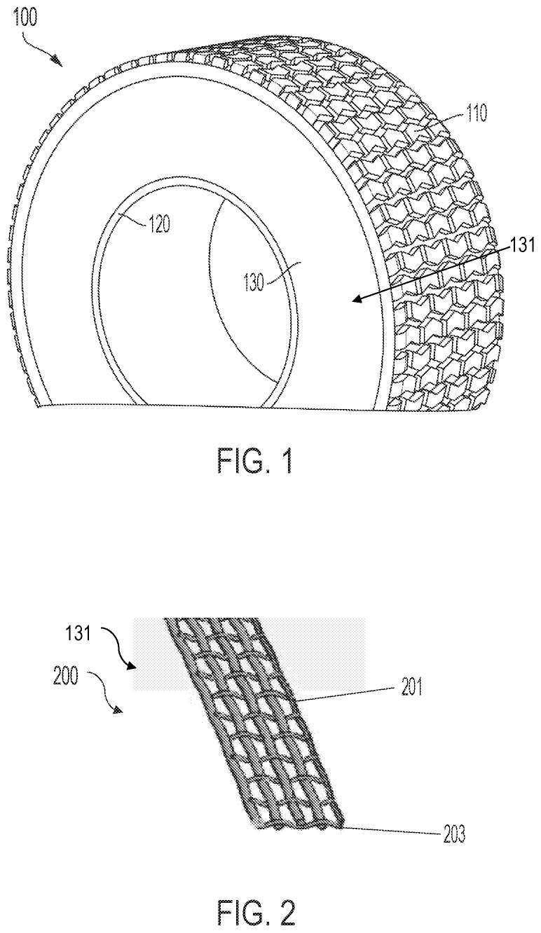

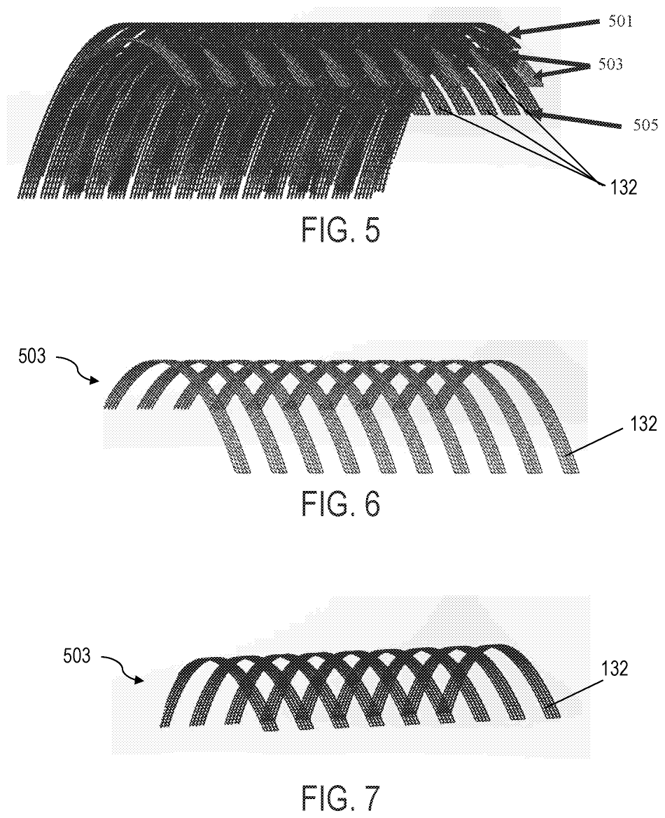

Provided herein are a non-pneumatic tire and methods of making the same. In some embodiments, as illustrated in FIG. 1, the non-pneumatic tire 100 includes an outer annular portion 110, an inner annular portion 120, and a load bearing ring 130 positioned therebetween. The load bearing ring 130 is positioned between the inner annular portion 120 and the outer annular portion 110, and is uniquely constructed as a composite with one or more reinforcing layers 131. Each reinforcing layer 131 is formed from one or more strips 132 (FIGS. 5-7) of multi angle tension control reinforcement (MATCR) material. As illustrated in FIGS. 2-4, the MATCR material includes a woven construction with circumference wire or cord (warp wire) 201 and weft wire or cord 203. The warp wire 201 provides circumferential strength while the weft wire 203 deforms the warp wire 201 radially to provide tension support and shear modulus in both the radial and lateral directions. The weft wire 203 also provides lateral stiffness for the tire. Accordingly, in some embodiments, the warp wire 201 and/or the weft wire 203 have a tensile strength of between 0.1 and 50,000 Newtons, 0.1 and 25,000 Newtons, 0.1 and 15,000 Newtons, 0.1 and 10,000 Newtons, or any suitable combination, sub-combination, range, or sub-range thereof.

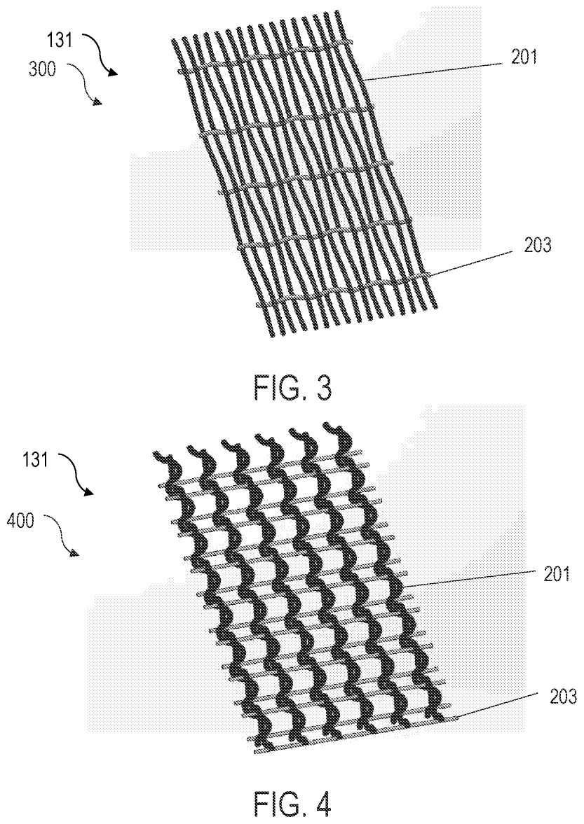

As will be appreciated by those skilled in the art, the arrangement and configuration of the warp wire 201 and the weft wire 203 may be selected to provide desired properties in the reinforcing layer(s) 131. In some embodiments, the warp wire 201 and the weft wire 203 include various arrangements to provide different tension support. For example, in some embodiments, as illustrated in FIG. 2, the weft wire 203 alternates between going over and under each consecutive warp wire 201. In another example, as illustrated in FIG. 3, the weft wire 203 alternates between going over and under every two consecutive warp wires 201. In a further example, as illustrated in FIG. 4, the weft wire 203 passes through twisted warp wires 201. Additionally or alternatively, the warp wire 201 and the weft wire 203 may independently include any suitable end per inch (EPI) based upon the application of the tire. Suitable EPI include, but are not limited to, at least 10, up to 40, between 10 and 40, about 25, or any combination, sub-combination, range, or sub-range thereof. Additionally or alternatively, the warp wire 201 and the weft wire 203 may independently be formed from any suitable material. Suitable materials include, but are not limited to, cotton, nylon, polyester, aramid, rayon, steel or other strengthening materials, composites, or a combination thereof. In some embodiments, the MATCR and/or reinforcing layer is coated with rubber and or other polymer composite materials.

In some embodiments, the load bearing ring 130 includes more than one reinforcing layer 131, such as, but not limited to, at least 2, at least 3, at least 4, at least 5, at least 6, between 2 and 10, between 3 and 8, between 4 and 6 reinforcing layers 131, or any combination, sub-combination, range, or sub-range thereof. For example, as illustrated in FIG. 5, in some embodiments, the composite includes a top layer 501 or layers of reinforcing material, an intermediate layer 503 or layers of reinforcing material, and a bottom layer 505 or layers of reinforcing material. When multiple reinforcing layers 131 are present, the different reinforcing layers 131 of the composite may have different angle and/or gap to provide a different shear modulus between the layers (FIGS. 6-7). For example, in one embodiment, the top 501 and bottom 505 layers of reinforcing material have decreased angle (measured between the warp to the circumference line) as compared to the intermediate layer(s) 503 of reinforcing material. In another embodiment, the angle is between 0 and 90 degrees. This difference in shear modulus between reinforcing layers 131 provides a uniform contact patch on the ground for the non-pneumatic tire 100. Additionally or alternatively, in some embodiments, the top layer 501 includes a matrix material and/or the bottom layer 505 includes a matrix material.

In some embodiments, the load bearing ring 130 may have rubber or other polymer composite material in between reinforcing layers 131, strips of the MATCR 132, and/or individual fibers of the MATCR. For example, in some embodiments, the reinforcing layers 131 may be coated with rubber or other polymer composite material. In such embodiments, the coating may include differing gauges, which generate different modulus in both the radial and lateral direction. Additionally or alternatively, the different layers 131 may wrap up continuously, intermittently or in different gaps. For example, in some embodiments, the bottom layer 505 and the intermediate layer 503 wrap up continuously, as opposed to other embodiments, where the bottom layer 505 is wrapped up, then the intermediate layer 503 is wrapped up. In some embodiments, the gaps between different strips 132 of reinforcing material (see FIG. 5) are variable.

The outer annular portion 110 forms an outer surface of the tire. In some embodiments, the outer annular portion 110 has a tensile modulus, at 10% strain, of between 0.1 and 100 MPa, between 0.1 and 75 MPa, between 0.1 and 50 MPa, between 0.1 and 40 MPa, between 0.1 and 30 MPa, between 0.1 and 25 MPa, between 0.1 and 20 MPa, between 0.2 and 100 MPa, between 0.2 and 50 MPa, between 0.2 and 30 MPa, between 0.2 and 25 MPa, between 0.2 and 20 MPa, between 0.3 and 100 MPa, between 0.3 and 50 MPa, between 0.3 and 30 MPa, between 0.3 and 25 MPa, between 0.3 and 20 MPa, between 0.4 and 100 MPa, between 0.4 and 50 MPa, between 0.4 and 30 MPa, between 0.4 and 25 MPa, between 0.4 and 20 MPa, or any combination, sub-combination, range, or sub-range thereof. In one embodiment, for example, the outer annular portion 110 has a tensile modulus of between 0.2 and 50 MPa at 10% strain. In another embodiment, the outer annular portion 110 has a tensile modulus of between 0.4 and 20 MPa at 10% strain. Such outer annular portions 110 may be formed from any suitable material known in the art. Suitable materials of the outer annular portion include, but are not limited to, thermoplastics (e.g., nylon, polyesters, TPU, olefins), thermosets (e.g., polyurethane (PU), rubber, epoxy, unsaturated polyesters, silicone), composites, or a combination thereof.

In some embodiments, the outer annular portion 110 is one layer and includes any suitable tread pattern 140 (FIG. 1) formed therein. For example, in one embodiment, the outer annular portion 110 includes one or more tread blocks. In some embodiments, the outer annular portion 110 includes an external surface layer and one or more sub-surface layers. The external surface layer is continuous or segmented, is arranged and disposed to contact the ground, and includes any suitable geometry for forming the tread pattern 140. For example, the external surface layer may include a smooth geometry, a patterned geometry (e.g., lugs, sipes), or any other suitable geometry for forming a tread pattern 140. The one or more sub-surface layers are radially positioned beneath the external surface layer. Each of the external surface layer and the one or more sub-surface layers is formed from any of the outer annular portion materials disclosed herein, and may be formed from the same material or a different material. For example, in one embodiment, the sub-surface layer(s) may be formed from a different thermoplastic, thermoset, or combination thereof, as compared to the external surface layer. Additionally or alternatively, one or more of the sub-surface layers may be reinforced with a fabric, continuous fiber, discontinuous fiber, metal, any other suitable reinforcing material, or a combination thereof.

Each external surface layer and one or more sub-surface layers, when present, independently includes any modulus disclosed herein for the outer annular portion 110. In some embodiments, the external surface layer and the one or more sub-surface layers include the same tensile modulus. Alternatively, in some embodiments, the external surface layer includes a lower tensile modulus than the one or more sub-surface layers. For example, in one embodiment, the external surface layer includes one or more rubber tread blocks with a tensile modulus of between 0.4 and 20 MPa, and the sub-surface layer includes a polyurethane with a tensile modulus of between 0.1 and 75 MPa. In another embodiment, the external surface layer is a retread layer and the sub-surface layer is a previous and/or buffed tread layer, the retread layer and the previous/buffed tread layer including the same or different materials.

In some embodiments, the inner annular portion 120 is in direct contact with a wheel hub. Alternatively, in some embodiments, the inner annular portion 120 is the wheel hub. The inner annual portion 120 is formed from any suitable material for contacting or forming the wheel hub. Suitable materials for the inner annual portion 120 include, but are not limited to, metal, polymer, composite, ceramic, any other suitable material, or a combination thereof.

In some embodiments, the tire 100 includes a radially outer sidewall and/or a radially inner sidewall. When present, the radially outer sidewall extends from a radially outer edge of the annular outer surface to a radially outer edge of the annular inner surface. Similarly, when present, the radially inner sidewall extends from a radially inner edge of the annular outer surface to a radially inner edge of the annular inner surface. As will be understood by those skilled in the art, the non-pneumatic tires of the present disclosure are not inflated with pressurized air and thus do not require a radially outer sidewall or radially inner sidewall to form an air-tight cavity. Nevertheless, when present, the radially outer sidewall and/or radially inner sidewall may partially carry the load on the tire, provide lateral stability to the tire, and/or prevent debris from entering and possibly damaging the inner portion of the tire.

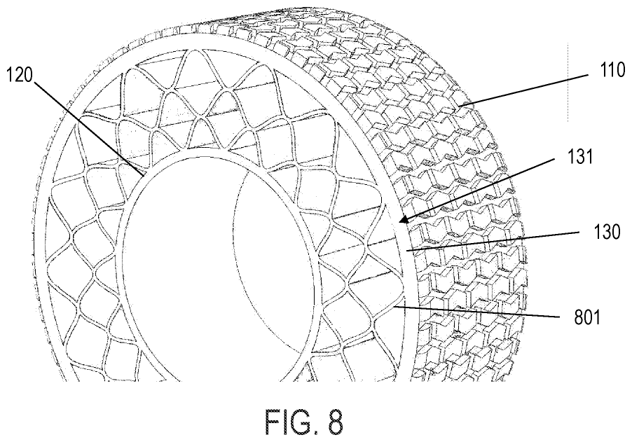

Additionally or alternatively, in some embodiments, as illustrated in FIG. 8, the non-pneumatic tire includes spokes and/or webbing 801 between the load bearing ring 130 and the inner annular portion 120. In some embodiments, the spokes and/or webbing 801 link the load bearing ring 130 to the inner annular portion 120. The spokes and/or webbing 801 may include any suitable shape and size, and may be formed from any suitable material such as, but not limited to, thermoplastic, thermoset, metal, continuous fiber, discontinuous fiber, composite, or a combination thereof. Suitable radial shapes include, but are not limited to, sinusoidal, web, straight, curved, any other suitable shape, or a combination thereof. Suitable lateral shapes include, but are not limited to, continuous through the width of the tires, discontinuous through the width of the tire, or a combination thereof.

The non-pneumatic tire 100 according to one or more of the embodiments disclosed herein is capable of carrying a load without internal air pressure. In some embodiments, the non-pneumatic tire 100 carries a load from the outer annular portion 110 through the load bearing ring 130 to the inner annular portion 120. In one embodiment, when carrying a load the spokes and/or webbing 801 are in tension outside a contact patch of the tire and both in compression and tension within the contact patch of the tire (e.g., as a spoke within the contact patch bends, one side will be in compression while the opposite side will be in tension). In another embodiment, the inner layer of matrix material and/or the outer layer of matrix material are put into shear as the tension and/or compression distorts the woven reinforcing layer 131. In another embodiment, the woven reinforcing layers 131 gauge, gap, angle, layers quantity can be tuned to create a flat contact patch, which provides improved stability and traction as compared to existing non-pneumatic tires.

All publications, patents, and patent applications mentioned in this specification are herein incorporated by reference to the same extent as if each individual publication, patent, or patent application was specifically and individually indicated to be incorporated by reference.

While the disclosure is susceptible to various modifications and alternative forms, specific embodiments thereof have been shown by way of example in the drawings and are herein described below in detail. It should be understood, however, that the description of specific embodiments is not intended to limit the disclosure to cover all modifications, equivalents and alternatives falling within the spirit and scope of the disclosure as defined by the appended claims.

1. A non-pneumatic tire comprising:
an outer annular portion;
an inner annular portion; and
a load bearing ring positioned between the outer annular portion and the inner annular portion;
wherein the load bearing ring comprises at least one reinforcing layer; and
wherein each of the at least one reinforcing layers comprises one or more strips of multi angle tension control reinforcement (MATCR) material.

2. The tire of claim 1, wherein the MATCR material comprises a woven construction including a warp wire and a weft wire.

3. The tire of claim 2, wherein the warp wire provides circumferential strength to the composite.

4. The tire of claim 2, wherein the weft wire deforms the warp wire radially, providing tension support and shear modulus in both the radial and lateral directions.

5. The tire of claim 2, wherein the weft wire provides lateral stiffness.

6. The tire of claim 2, wherein the warp wire and the weft wire independently have a tensile strength of between 0.1 and 50,000 Newtons.

7. The tire of claim 2, wherein the weft wire alternates between going over and under each consecutive warp wire.

8. The tire of claim 2, wherein the weft wire alternates between going over and under every two consecutive warp wires.

9. The tire of claim 2, wherein the weft wire passes through twisted warp wires.

10. The tire of claim 2, wherein the warp wire and weft wire independently include up to 40 ends per inch.

11. The tire of claim 2, wherein the warp wire and weft wire independently include a material selected from the group consisting of cotton, nylon, polyester, aramid, rayon, steel or other strengthening materials, composites, and combinations thereof.

12. The tire of claim 1, wherein the at least one reinforcing layer is coated with rubber, other polymer composite materials, or a combination thereof.

13. The tire of claim 1, wherein the at least one reinforcing layer comprises between 2 and 10 reinforcing layers.

14. The tire of claim 1, wherein the load bearing ring further comprises an outer matrix material between the at least one reinforcing layer and the outer annular portion.

15. The tire of claim 1, wherein the load bearing ring further comprises an inner matrix material between the at least one reinforcing layer and the inner annular portion.

16. The tire of claim 1, wherein the outer annular portion includes a tread pattern.

17. The tire of claim 16, wherein the outer annular portion includes one or more sub-surface layers radially positioned beneath the tread pattern.

18. The tire of claim 1, wherein the inner annular portion is in direct contact with a wheel hub.

19. The tire of claim 1, wherein the tire includes a radially inner sidewall and a radially outer sidewall.

20. The tire of claim 1, wherein the tire further comprises spokes between the load bearing ring and the inner annular portion.
